(19) United States
(12) Patent Application Publication
(10) Pub. No.: US 2009/0148026 A1
(43) Pub. Date: Jun. 11, 2009

(54) Currency recognition apparatus and information updating method thereof

(75) Inventors: Shih-Ming Shen, Taipei City (TW); Chi-Tsung Lee, Taipei City (TW)

Correspondence Address: BIRCH STEWART KOLASCH & BIRCH, PO BOX 747, FALLS CHURCH, VA, 22040-0747, US

(73) Assignee: INTERNATIONAL CURRENCY TECHNOLOGIES CORPORATION

(21) Appl. No.: 12/010,073

(22) Filed: Jan. 18, 2008

(30) Foreign Application Priority Data
Dec. 7, 2007 (TW) 096146677

(51) Int. Cl. G06K 9/00

(52) U.S. Cl. 382/135

(57) ABSTRACT

The invention discloses a currency recognition apparatus and an information updating method thereof. The currency recognition apparatus according to the invention includes a transmitting module and an updatable memory. The transmitting module receives or transmits the updated information related to the currency recognition apparatus through a network. The updatable memory is electrically connected to the transmitting module and stores the updated information.

### BACKGROUND OF THE INVENTION

1. Field of the Invention

This invention relates to a currency recognition apparatus, and more particularly, to a currency recognition apparatus which is able to receive or transmit the updated information related, to the currency recognition apparatus through a network.

2. Description of the Prior Art

Up to the present, currency recognition apparatuses have been installed in a lot of equipment, such as a vending machine, a MRT top up machine, an exchange machine, a currency count machine, etc. Most of currency recognition apparatuses regard physical properties and characteristics of currency as comparison targets, so as to recognize the type of currency which a user put into the slot.

For instance, as for a paper money recognition apparatus, a LED light source emits light into one side of a paper money, and a sensor is disposed at the opposite side of the paper money for sensing the light field generated after the emitted light passes through, so as to recognize whether the paper money is genuine.

Moreover, the kinds of currencies issued by every country in the world or tokens designed by playgrounds are continuously improved, so the information related to currency properties in a currency recognition apparatus has to be updated as well. For instance, sensors for sensing the light field must continuously update the light field information corresponded by currencies with the new type, so as to cooperate the emission of currencies of the new type.

However, the traditional update processes requires workers to accomplish the tasks personally, so it wastes time and manpower cost. Furthermore, if the currency recognition apparatus has a breakdown or needs to update the internal program, it still requires workers to accomplish the tasks personally.

Accordingly, the objective of the invention is to provide a currency recognition apparatus to solve the above-mentioned problems.

### SUMMARY OF THE INVENTION

A scope of the invention is to provide a currency recognition apparatus and an information updating method related to the currency recognition apparatus.

An embodiment according to the invention is a currency recognition apparatus. The currency recognition apparatus includes a transmitting module and an updatable memory. The transmitting module receives or transmits updated information related to the currency recognition apparatus through a network. The updatable memory is electrically connected to the transmitting module and is used for storing the updated information.

Another embodiment according to the invention is a currency recognition apparatus. The currency recognition apparatus includes a recognition module, a mechanical module, a storage module, a transmitting module, and an updatable memory.

The recognition module is used for recognizing a currency. In practice, the mechanical module transmits the currency after the currency is inputted, and then the currency is stored in the storage module. The transmitting module receives or transmits updated information related to the currency recognition apparatus through a network. The updatable memory is electrically connected to the transmitting module and is used for storing the updated information.

Another embodiment according to the invention is an information updating method related to a currency recognition apparatus. First, the method adopts the step of receiving or transmitting updated information related to the currency recognition apparatus through a network. After that, the method adopts the step of storing the updated information updatably.

Compared with prior arts, the currency recognition apparatus according to the invention is capable of receiving or transmitting the updated information related to the currency recognition apparatus through the network, such as currency recognition information or state controlling information. Accordingly, by using the currency recognition apparatus according to the invention, the traditional repairing or the update processes accomplished by workers personally can be canceled, so as to save time and manpower cost.

The advantage and spirit of the invention may be understood by the following recitations together with the appended drawings.

### BRIEF DESCRIPTION OF THE APPENDED DRAWINGS

FIG. 1 is a function block diagram illustrating a currency recognition apparatus according to a first embodiment of the invention.

FIG. 2 is a function block diagram illustrating a currency recognition apparatus according to a second embodiment of the invention.

FIG. 3 is a function block diagram illustrating a currency recognition apparatus according to a third embodiment of the invention.

FIG. 4A is an appearance view showing a currency recognition apparatus according to a fourth embodiment of the invention.

FIG. 4B is an appearance view and a partial interior view showing a currency recognition apparatus according to the fourth embodiment of the invention.

FIG. 5 is a function block diagram illustrating a currency recognition apparatus according to the fourth embodiment of the invention.

### DETAILED DESCRIPTION OF THE INVENTION

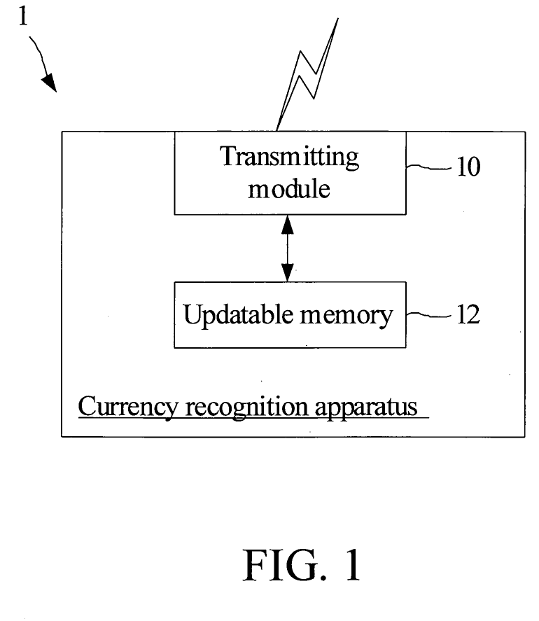

Please refer to FIG. 1. FIG. 1 is a function block diagram illustrating a currency recognition apparatus 1 according to a first embodiment of the invention. In a practical application, the currency recognition apparatus 1 can be installed in, but not limited to, a vending machine, a MRT top up machine, an exchange machine, or a currency count machine.

As shown in FIG. 1, the currency recognition apparatus 1 includes a transmitting module 10 and an updatable memory 12. The transmitting module 10 receives or transmits updated information related to the currency recognition apparatus 1 through a network. The updatable memory 12 is electrically connected to the transmitting module 10 and is used for storing the updated information.

For instance, the updated information is able to include currency recognition information. The currency can be a statutory coin, a statutory paper money, or any token designed for being used at playgrounds or other consumer places. And, the currency recognition information can include, but not limited to, a pattern, a size, and an anti-counterfeiting character. Hence, when a new currency is issued, the recognition information of the new currency can be transmitted to the transmitting module 10 through the network and then stored in the updatable memory 12. Thus, suppliers need not to dispatch workers to update the recognition information of the new currency personally.

Furthermore, the updated information can include state controlling information of the currency recognition apparatus 1. The state controlling information can include a lump sum of currency have been received by the currency recognition apparatus 1. Or, the state controlling information can include the driver information or signal controlling information of the currency recognition apparatus 1, such as the switching of power, the flashing of a LED, the driving of a motor, etc. Thus, suppliers are not only able to acquire the information of the lump sum of currency, but also able to dispatch workers to repair the currency recognition apparatus 1 immediately while there is a breakdown.

The currency recognition apparatus 1 generates a corresponding motion after the transmitting module 10 receives the driver information or the signal controlling information. The corresponding motion can be the foregoing switching of power, the flashing of a LED, the driving of a motor, etc.

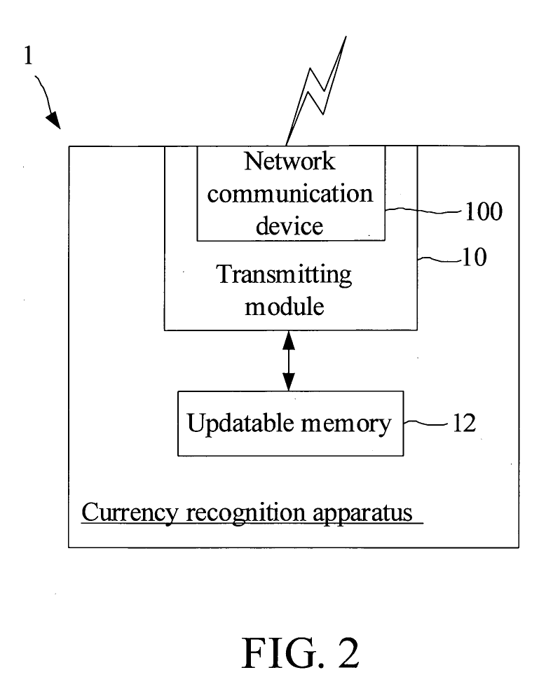

Please refer to FIG. 2. FIG. 2 is a function block diagram illustrating a currency recognition apparatus 1 according to a second embodiment of the invention.

As shown in FIG. 2, the transmitting module 10 can include a network communication device 100, and the network communication device 100 is connected to the network directly to receive or transmit the updated information. In a practical application, the network can be a wired network or a wireless network.

If the network is a wired network, the wired network can be, but not limited to, a NetBEUI (NetBIOS Extended User Interface) protocol, a TCP/IP protocol, a DLC (Data Link Control) protocol, or an IPX (Internetwork Packet Exchange)/SPX (Sequenced Packet Exchange) protocol.

If the network is a wireless network, the wireless network can use, but not limited to, an IEEE 802.15.4 protocol, IEEE 802.11-based protocols, a Wi-MAX protocol, or a Bluetooth protocol.

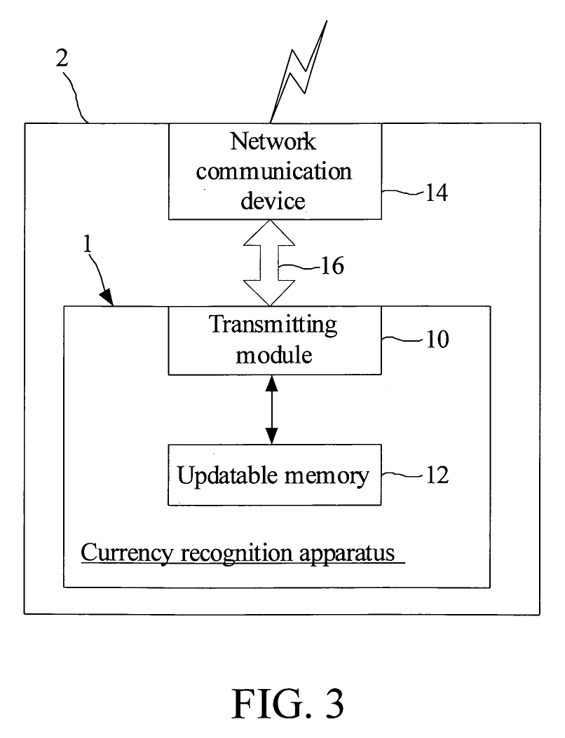

Please refer to FIG. 3. FIG. 3 is a function block diagram illustrating a currency recognition apparatus 1 according to a third embodiment of the invention.

As shown in FIG. 3, the currency recognition apparatus 1 also includes a network communication device 14. The network communication device 14 is unlike the network communication device 100 installed in the transmitting module 10, but is capable of being installed in equipment which accommodates the currency recognition apparatus 1 and outside the currency recognition apparatus 1. The network communication device 14 is connected to the network directly to receive or transmit the updated information. After that, the transmitting module 10 is connected to the network communication device 14 by a transmission interface 16 to receive or transmit the updated information.

In a practical application, the transmission interface 16 can be, but not limited to, a pulse interface, a RS232 interface, a NISR interface, a MDB (multi-drop bus) interface, a CC-Talk interface, or a parallel port interface.

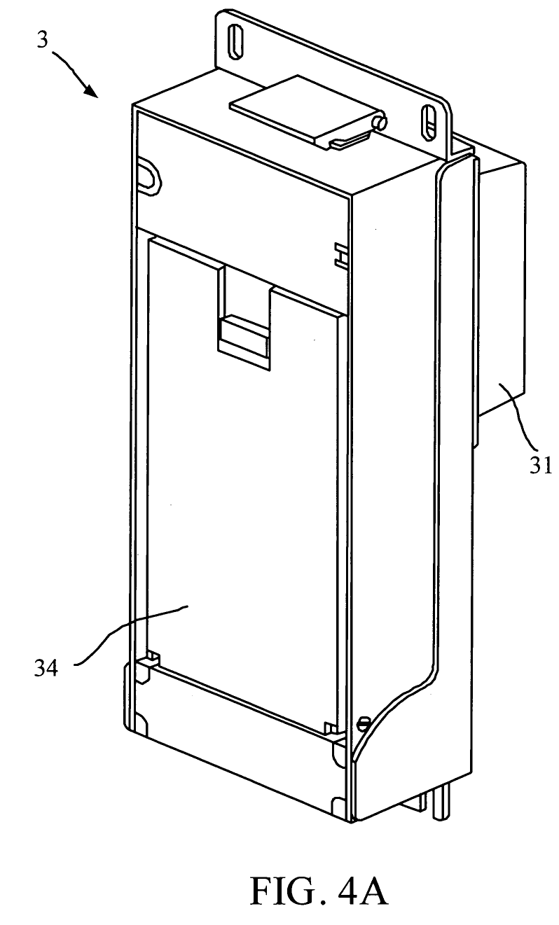

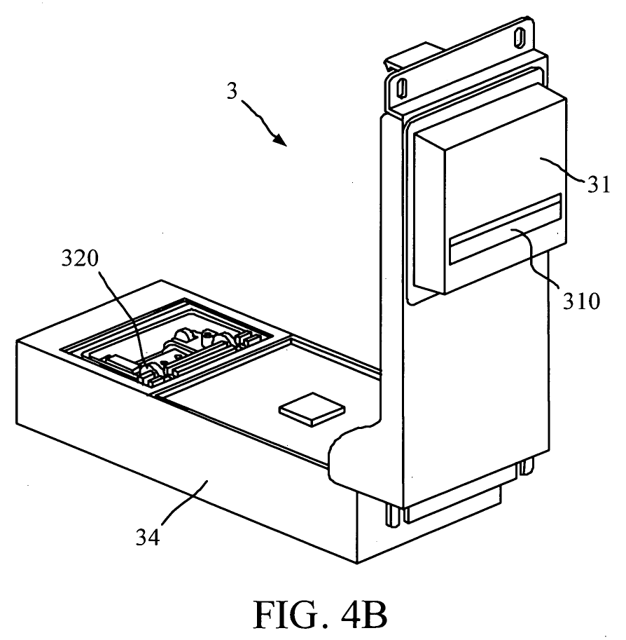

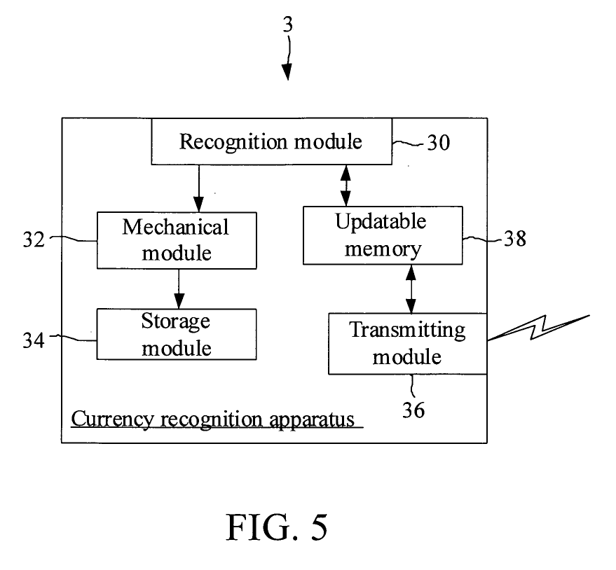

Please refer to FIG. 4A, FIG. 4B, and FIG. 5. FIG. 4A is an appearance view showing a currency recognition apparatus 3 according to a fourth embodiment of the invention. FIG. 4B is an appearance view and a partial interior view showing a currency recognition apparatus 3 according to the fourth embodiment of the invention. FIG. 5 is a function block diagram illustrating a currency recognition apparatus 3 according to the fourth embodiment of the invention.

As shown in FIG. 5, the currency recognition apparatus 3 includes a recognition module 30, a mechanical module 32, a storage module 34, a transmitting module 36, and an updatable memory 38. As shown in FIG. 4A and FIG. 4B, the currency recognition apparatus 3 includes a panel 31 and the storage module 34. The panel has a currency inputting slot 310. As shown in FIG. 4B, the mechanical module 32 can include a roller 320 for transmitting the currency.

The recognition module 30 (not shown in FIG. 4A and FIG. 4B) is used for recognizing the currency after the currency is inputted into the currency inputting slot 310. The recognition module 30 can include, but not limited to, a LED light source and a sensor for recognizing the currency.

After the recognition module 30 recognizes the currency and the currency is recognized as real, the currency is transmitted to be stored in the storage module 34. Particularly, the transmitting module 36 receives or transmits updated information related to the currency recognition apparatus 3 through a network. The updatable memory 38 is electrically connected to the transmitting module 36 and is used for storing the updated information.

For instance, the updated information can include currency recognition information, and the recognition module 30 recognizes the currency according to the currency recognition information. The currency recognition information can include, but not limited to, a pattern, a size, and an anti-counterfeiting character corresponded to a currency waiting for recognition.

Besides, the updated information can include state controlling information of the currency recognition apparatus 3. The state controlling information can include a lump sum of currency have been received by the currency recognition apparatus 3. Or, the state controlling information can include the driver information or signal controlling information of the currency recognition apparatus 3, such as the switching of power, the flashing of a LED, the driving of a motor, etc.

A fifth embodiment according to the invention is an information updating method related to a currency recognition apparatus. First, the method adopts the step of receiving or transmitting updated information related to the currency recognition apparatus through a network. After that, the method adopts the step of storing the updated information updatably.

Compared with prior arts, the currency recognition apparatus according to the invention is capable of receiving or transmitting the updated information related to the currency recognition apparatus through the network, such as currency recognition information or state controlling information. Accordingly, by using the currency recognition apparatus according to the invention, the traditional repairing or the update processes accomplished by workers personally can be canceled, so as to save time and manpower cost.

With the example and explanations above, the features and spirits of the invention will be hopefully well described. Those skilled in the art will readily observe that numerous modifications and alterations of the device may be made while retaining the teaching of the invention. Accordingly, the above disclosure should be construed as limited only by the metes and bounds of the appended claims.

What is claimed is:

1. A currency recognition apparatus comprising:
a transmitting module receiving or transmitting updated information related to the currency recognition apparatus through a network; and
an updatable memory, electrically connected to the transmitting module, for storing the updated information.

2. The currency recognition apparatus of claim 1, wherein the updated information comprises currency recognition information.

3. The currency recognition apparatus of claim 2, wherein the currency recognition information comprises one selected from a group consisting of a pattern, a size, and an anti-counterfeiting character corresponded to a currency waiting for recognition.

4. The currency recognition apparatus of claim 1, wherein the updated information comprises state controlling information.

5. The currency recognition apparatus of claim 4, wherein the state controlling information comprises the driver information or signal controlling information of the currency recognition apparatus.

6. The currency recognition apparatus of claim 6, wherein the currency recognition apparatus generates a corresponding motion after the transmitting module receives the driver information or the signal controlling information.

7. The currency recognition apparatus of claim 4, wherein the state controlling information comprises a lump sum of currency which have been received by the currency recognition apparatus.

8. The currency recognition apparatus of claim 1, wherein the transmitting module comprises a network communication device, the network communication device is connected to the network directly to receive or transmit the updated information.

9. The currency recognition apparatus of claim 1, wherein the currency recognition apparatus also comprises a network communication device, the network communication device is connected to the network directly to receive or transmit the updated information, and the transmitting module is connected to the network communication device by a transmission interface to receive or transmit the updated information.

10. The currency recognition apparatus of claim 9, wherein the transmission interface is one selected from a group consisting of a pulse interface, a RS232 interface, a NISR interface, a MDB (multi-drop bus) interface, a CC-Talk interface, and a parallel port interface.

11. The currency recognition apparatus of claim 1, wherein the network is a wired network or a wireless network.

12. The currency recognition apparatus of claim 11, wherein the wired network is one selected from a group consisting of a NetBEUI (NetBIOS Extended User Interface) protocol, a TCP/IP protocol, a DLC (Data Link Control) protocol, and an IPX (Internetwork Packet Exchange)/SPX (Sequenced Packet Exchange) protocol.

13. The currency recognition apparatus of claim 11, wherein the wireless network uses a wireless communication protocol, the wireless communication protocol is one selected from a group consisting of an IEEE 802.15.4 protocol, IEEE 802.11-based protocols, a Wi-MAX protocol, and a Bluetooth protocol.

14. A currency recognition apparatus comprising:
a recognition module for recognizing a currency;
a mechanical module transmitting the currency after the currency is inputted;
a storage module for storing the currency;
a transmitting module receiving or transmitting updated information related to the currency recognition apparatus through a network; and
an updatable memory, electrically connected to the transmitting module, for storing the updated information.

15. The currency recognition apparatus of claim 14, wherein the updated information comprises currency recognition information.

16. The currency recognition apparatus of claim 15, wherein the recognition module recognizes the currency according to the currency recognition information.

17. The currency recognition apparatus of claim 16, wherein the currency recognition information comprises one selected from a group consisting of a pattern, a size, and an anti-counterfeiting character corresponded to a currency waiting for recognition.

18. The currency recognition apparatus of claim 14, wherein the updated information comprises state controlling information.

19. The currency recognition apparatus of claim 18, wherein the state controlling information comprises the driver information or signal controlling information of the currency recognition apparatus.

20. An information updating method related to a currency recognition apparatus, the method comprising the steps of:
receiving or transmitting updated information related to the currency recognition apparatus through a network; and
storing the updated information updatably.

21. The information updating method of claim 20, wherein the updated information comprises currency recognition information.

22. The information updating method of claim 21, wherein the currency recognition information comprises one selected from a group consisting of a pattern, a size, and an anti-counterfeiting character corresponded to a currency waiting for recognition.

23. The information updating method of claim 20, wherein the updated information comprises state controlling information.

24. The information updating method of claim 23, wherein the state controlling information comprises the driver information or signal controlling information of the currency recognition apparatus.
